(19) United States
(12) Patent Application Publication
(10) Pub. No.: US 2005/0122190 A1
(43) Pub. Date: Jun. 9, 2005

(54) VHF band pass filter built with ceramic coaxial resonator

(76) Inventor: Peter F. Chu, Poway, CA (US)

Correspondence Address: KATTEN MUCHIN ZAVIS ROSENMAN, 525 WEST MONROE STREET, CHICAGO, IL, 60661-3693, US

(21) Appl. No.: 10/727,691

(22) Filed: Dec. 4, 2003

(51) Int. Cl. H01P 1/205

(52) U.S. Cl. 333/202; 333/207

(57) ABSTRACT

A microwave filter for use at VHF frequencies provides a relatively high-Q without the need for the microstrip line or bulky mechanical resonators and varactors. The transmission line filter in accordance with the present invention utilizes a coaxial resonator, which obviates the need for microstrip line and strip line resonators, thus making the use of large ceramic substrates unnecessary. In accordance with another embodiment of the invention, switched capacitor arrays are used in place of the conventional varactors diode. As such, a microwave filter, suitable for VHF frequencies, is provided using relatively low cost off-the-shelf ceramic resonators which can be used to build a relatively low insertion loss high rejection band pass filter in the aviation band frequency range of 100 MHz to 200 MHz.

### BACKGROUND OF THE INVENTION

1. Field of the Invention

The present invention relates to a transmission line filter and more particularly to a tunable transmission line band pass filter, suitable for use in the VHF range. The transmission line can be coaxial cable, microstrip line or strip line, which provides relatively high-Q. The transmission line along with a capacitor (shunt or in series) forms a resonator.

2. Description of the Prior Art

Microwave filters are generally known in the art. Examples of such microwave filters are disclosed in U.S. Pat. Nos. 4,180,787; 4,352,076; 4,578,656; 4,641,116; 4,839,617; 5,066,933; 5,021,757; 5,241,291; 5,392,011; 5,485,131 and 5,138,288. Some known microwave filter circuits, for example, band pass filter circuits, are known to include a pair of resonators and a tuning element disposed between the resonators to define the pass band. Examples of such microwave filters are disclosed in U.S. Pat. Nos. 4,352,076; 4,578,656; 4,641,116 and 4,839,617.

Various devices are used to provide tuning of the filter circuit. For example, U.S. Pat. Nos. 5,021,757, 5,138,288 and 5,241,291 disclose the use of varactors for tuning the resonators. The performance of such varactor-tuned resonators (VTR) is also discussed in an article entitled, “Modeling Varactor Tunable Transmission Line Resonators for Wireless Applications” by Boris Kapilevich and Roman Lukyanets, Applied Microwave and Wireless, pages 32-34, September 1988.

In known band pass filters; two resonators are known to be coupled by way of a varactor. In such filters, the zero transmission frequency (i.e. frequency at which the RF energy transmission is a minimum) is tuned to exclude frequencies outside the pass band. In particular, the varactors are used to control the capacitance coupling between the resonators. By controlling the voltage applied to the varactors, the center frequency of the filter can be controlled thus providing the ability to tune the filter.

In the VHF range, relatively high-Q components are required. As such, resonators, which use discrete inductors, for example, as disclosed in U.S. Pat. Nos. 4,180,787, 4,839,617 and 5,392,011, are unsuitable, since such resonators include discrete inductors, which require a sufficiently high-Q. As such, for VHF frequencies, filters are known to use transmission line (or strip line) components formed on relatively expensive PC boards, such as Duroid. Examples of such filters are disclosed in U.S. Pat. Nos. 4,352,076; 4,578,656; 5,021,757; 5,066,933; 5,138,288 and 5,241,291. Duroid PCB (printed circuit board) significantly increases the cost of the device. Quarter wavelength Hi-Q ceramic coaxial resonators are also known to be used in filter circuits. Unfortunately, the ceramic λ/4 and λ/2 resonators in the VHF frequency range are not available for frequencies below 400 MHz because of physical size.

U.S. Pat. No. 5,484,131 discloses a transmission line, which includes a pair of generally parallel transmission lines capacitively coupled together. One end of each of the transmission lines is directly coupled to ground. An opposing end of each of the transmission lines is coupled to ground by way of a capacitive coupling. Unfortunately, for VHF frequencies, the physical size of the transmission lines required would be too large for the device to be practical. As such, there is a need for a relatively low cost microwave filter for use at VHF frequencies, which eliminates the need for expensive ceramic substrates.

### SUMMARY OF THE INVENTION

Briefly, the present invention relates to a microwave filter for use at VHF frequencies which utilizes a coaxial resonator. In accordance with another aspect of the invention switched capacitor arrays are used in place of the conventional varactors diode to achieve a high IP3 and digital control without a D to A converter. As such, a microwave filter, suitable for VHF frequencies, is provided using relatively low cost off-the-shelf ceramic coaxial resonators which can be used to build a relatively low insertion loss high rejection band pass filter in the frequency range of 100 MHz to 200 MHz.

### DESCRIPTION OF THE DRAWINGS

These and other advantages of the invention will be readily understood with reference to the following specification and attached drawings wherein:

FIG. 1 is a block diagram of the filter in accordance with the present invention.

FIG. 2 is a schematic diagram of the capacitor array, grounding switch array and digital interface illustrated in FIG. 1, which forms a part of the present invention.

FIG. 3 is a schematic diagram of an alternate embodiment of the invention.

FIG. 4 is a graphical illustration of the measured S21 parameter as a function of frequency for various combination of digital input, which changes the capacitance values.

FIG. 5 is a plot of test result of a passband filter built as illustrated in FIGS. 1 and 2.

### DETAILED DESCRIPTION

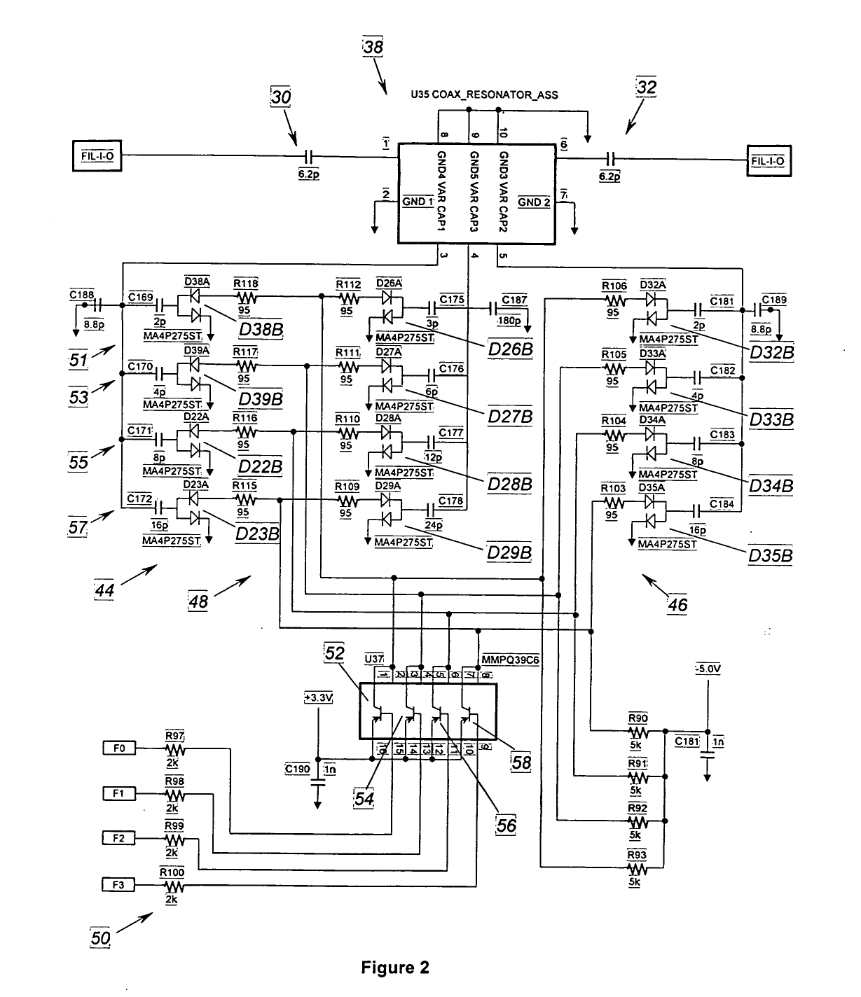

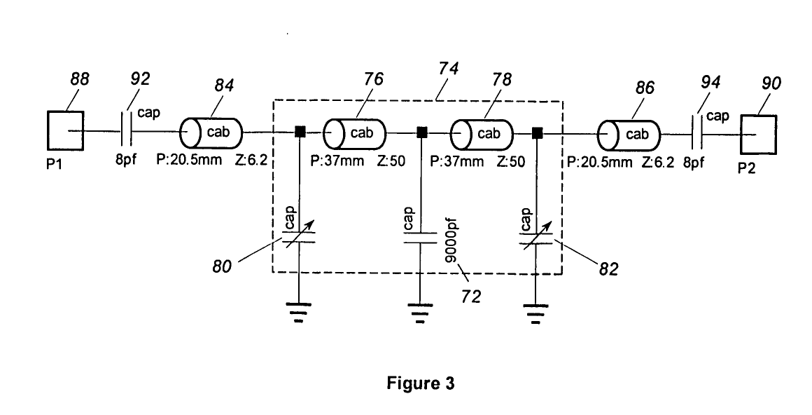

The present invention relates to a band pass microwave filter formed from off-the-shelf low cost components, which provides a relatively high-Q and low insertion loss in the VHF frequency range of 100 MHz to 200 MHz. An important aspect of the invention is that a ceramic coaxial resonator (as opposed to an λ/4 or λ/2 resonator) is used in place of known microstrip and strip line resonators in known VHF band pass filters. As is known in the art, such coaxial resonators 38 normally have high-Q. An alternate embodiment of the invention is shown in FIG. 3, in which a single large value fixed capacitor 72 replaces the resonators. In accordance with another important aspect of the invention, switched capacitors, as shown in FIG. 2 may be utilized in place of the varactors for tuning the resonator.

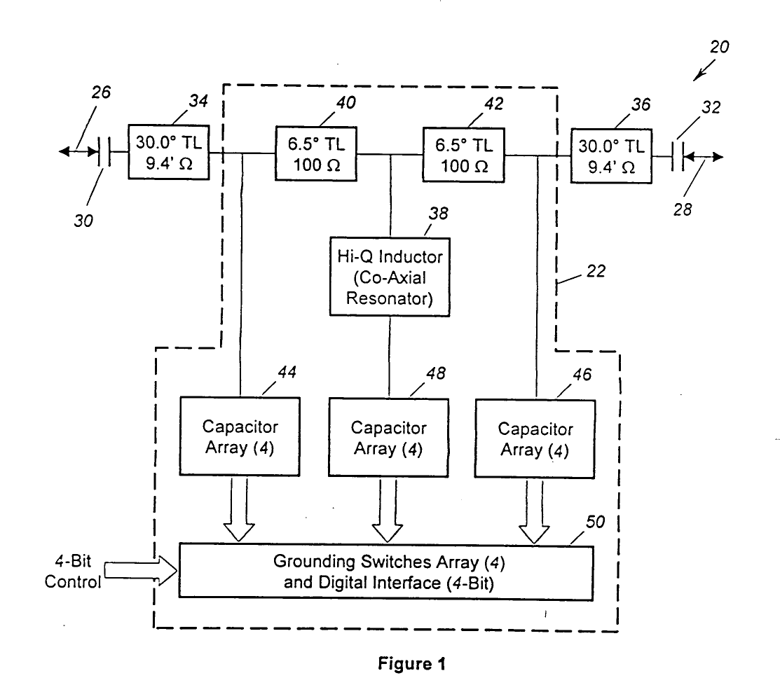

Turning to FIG. 1, a tunable VHF band pass filter, generally identified with the reference numeral 20, is illustrated which provides low insertion loss in the pass band and high rejection ratio outside of the pass band. The band pass filter 20 is formed from a resonator, shown within the dashed box 22, which includes a pair of transmission lines 40 and 42, a coaxial resonator 38, one or more capacitor arrays 44, 46 and 48 as well as a grounding switches array and digital interface 50. The filter 20 also includes a pair of bidirectional input/output ports, represented by the arrows identified with the reference numerals 26 and 28. The bidirectional input/output ports 26 and 28 are capacitively coupled to the filter 20 by way of a pair of capacitors 30 and 32 respectively. A pair of transmission lines 34 and 36, for example, 9.4 Ω, 30° transmission lines, are provided for synthesizing transmission zeros, such that the S-parameter S₁₁=0. In particular, the capacitors 30 and 32 are placed in series with the transmission lines 34 and 36 for impedance matching and for narrowing the bandwidth. The characteristic impedance Z₀ of transmission line 34, 36 is quite low as compared to that of the transmission line 40, 42, effectively shortening the length of the transmission lines 34 and 36. As shown in FIG. 1, the two high impedance transmission lines 40 and 42 are coupled together and to the coaxial resonator 38.

The coaxial resonator 38 may be an off-the-shelf ceramic coaxial resonator with a relatively high-Q and an electrical wavelength as small as 20°, for example as manufactured by Trans-Tech, Inc, Adamstown Md., part number SR9000SPH037SBY. The transmission lines 40 and 42 may be a pair of relatively high characteristic impedance Z₀ transmission lines, which can be a 100 Ω or higher Z₀ cable, about 40 mm, for example, part number R-1200-N37-0411-OA, available from SMI Electronic Devices of America, Inc, Hollister, Calif.

Rather than using varactor diodes for tuning the filter as is known in the art, a plurality of switched capacitor arrays 44, 46 and 48 are provided which, in turn, are coupled to a grounding switch array and a digital interface 50. This PIN diode-switching scheme will improve the third order intercept (IP₃) to +50 dBm making the filter 20 suitable for high power transmitter use.

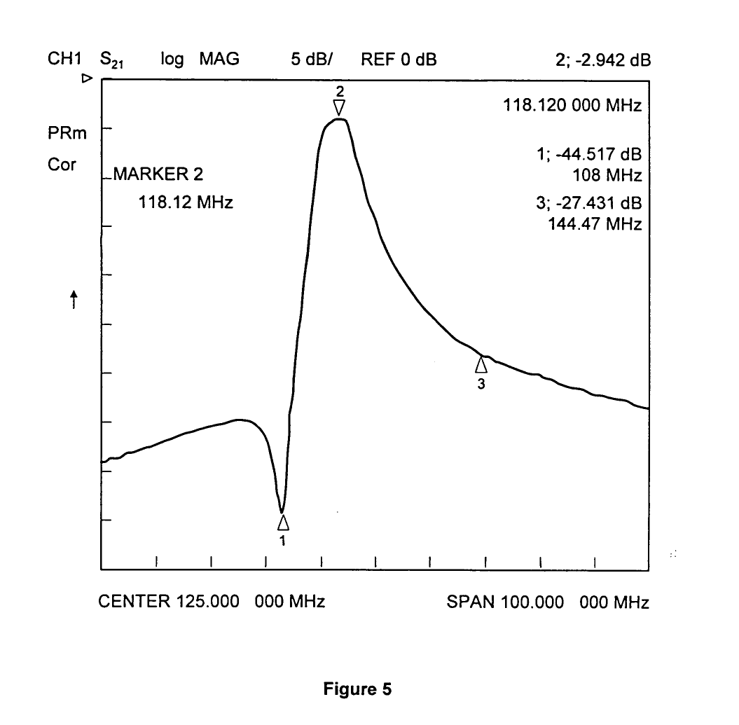

The configuration in accordance with the invention provides a transmission zero at about 10 MHz below the low turning point; see FIG. 5, Marker 1. This is important because it provides more than 41 dB rejection at 108 Mhz, the frequency of VHF TV stations. Also it helps shaping the Q of the filter in the aviation band.

The capacitor arrays 44, 46 and 48 together with the grounding switch array and digital interface 50 are used to tune the resonator 22. In particular, the capacitor arrays 44, 46 and 48 together with grounding switch array and digital interface 50 form a switched capacitor circuit whose capacitance varies as the control signals applied to the grounding switch array to enable the center frequency of the resonator 22 to be tuned to select a particular pass band for the filter 20.

One capacitor array 44 is connected at a node defined between the transmission lines 34 and 40 and ground. Similarly, the capacitor array 46 is connected between the node between transmission lines 36 and 42 and ground. The capacitor array 48 is serially coupled to the coaxial resonator 38, which, in turn, is coupled between a node defined between the transmission lines 40 and 42. The capacitor array 48 is also connected to ground.

A schematic diagram of the capacitor arrays 44, 46 and 48, as well as the grounding switch array and digital interface 50, is illustrated in FIG. 2. It is to be understood that the specific values and configuration illustrated in FIG. 2 are merely exemplary and that other component values and configurations are within the broad scope of the invention. Referring back to FIG. 1, the capacitor array 44 includes a fixed capacitor C 188 as well as four switched capacitors C 169, C 170, C 171 and C 172. As shown, exemplary component values for the capacitors C 169, C 170, C 171 and C 172 are provided as 2 pF, 4 pF, 8 pF and 16 pF, respectively. The capacitor array 46 is similar.

The capacitor array 48 includes a fixed capacitor C 187 and includes the parallel capacitors C 175; C 176; C 177 and C 178. Based upon the capacitance values illustrated, the capacitor array 48 includes 180 pF fixed capacitance and 3 pF, 6 pF, 12 pF and 24 pF switched capacitance.

The switching of the capacitors in the capacitor arrays 44, 46, and 48 is under the control of the grounding switch array in digital interface 50, which includes a four bit digital input F0, F1, F2, and F3. The four bit digital input is applied to the base terminals of four transistors 52, 54, 56 and 58, for example, bipolar junction transistors, by way of current limiting resistors R97, R98, R99 and R100. As shown, the grounding switch array and digital interface 50 thus provides 4-bit control of the capacitor arrays 44, 46 and 48. Each of the four PNP transistors 52, 54, 56 and 58 is used to switch any combination of the four-capacitor stages 51, 53, 55 and 57 for each of the capacitor arrays 44, 46 and 48. For example, the switch 52 controls the switching of stage 51 and thus switches the capacitors C169, C175 and C181. Thus, when a logical “1” is applied to the input F0, the capacitor array 44 will include the fixed capacitor C188 plus the switched capacitor 169. Similarly, the capacitor array 48 will include the fixed capacitor C189, as well as the switched capacitor C181. The capacitor array 148 will include the fixed capacitor C187 plus the switched capacitor C169 and C175. The capacitor's values are in binary order, which means that the 4 control lines, driven by a 4-bit binary number, will generate 3 sets of 16 different values of capacitance.

Control of the capacitance is accomplished by way of one or more pairs of reverse connected diodes. For example, in capacitor array 44, a fixed capacitor 188 is connected on one end to the group capacitors C169 to C172. A pair of diodes, D38A and D38B is connected to the other end of the capacitor C169. In particular, the cathode of the diode D38A is connected to the capacitor C169 while the anode is connected to a current limiting resistor R118 and to the switching transistor 52. The cathode of the diode D38A is coupled to the anode of the diode D38B inside package. The anode of the diode D38B is connected to ground. The configuration of the other sets and the capacitor array 46 is similar.

The same digital lines control the three sets of capacitor arrays 44, 48 and 46. For example, capacitors C175 and C169 in stage 51 and C181 are turned on or off as a group by the control signal F0. Similarly, the capacitors C170, C182 and C176 in stage 53 are controlled as a group by the control signal F1. The switched capacitors C171, C183 and C177 in stage 55 are controlled as a group by control signal F2. Finally, the capacitors C172, C184 and C178 in stage 57 are controlled as a group by the control signal F3. At the highest frequency band, the least capacitance is required. As such, only the fixed capacitors C 187, C 188 and C 189 are connected. The switched capacitors are switched off by way of a negative voltage, for example—5.0 volts, applied to the anodes of the diodes in each of the four stages 51, 53, 55, and 57 by way of current limiting resistors R 90, R 91, R 92 and R 93. The negative voltage applied to the anodes maintains all of the diodes in a reverse biased condition. In order to switch the diodes on, a positive voltage, for example 3.3 volts, is connected to the emitters of the transistors 52, 54, 56 and 58. A logical “0”, that is “LOW” or ground, applied to the base of PNP BJTs 52, 54, 56 and 58 will cause these transistors to turn on and apply the positive voltage (i.e. 3.3 volts) to the anodes of the diodes in order to forward bias the diodes and connect the switched capacitors to the circuit. In particular, assuming a logical “0” is input as the control signal F0, the transistor 52 will be turned on and forward bias the diodes D26A, D26B, D32A, D32B and D38A, D38B. Once all the 6 diodes are turned on, the capacitors C181, C175 and C169 are AC grounded. During such a condition the capacitor array 44 will include the fixed capacitor C188, shown as 8 pF, and a parallel capacitor C169, 2 pF. The capacitor 46 will operate in a similar manner.

A logical “0” is applied as the input F0 will also cause the capacitor C175 to be in parallel with the fixed capacitor C187. The other stages operate in a similar manner. Table 1 illustrates the fixed and switchable capacitance values for all four stages 51, 53, 55 and 57 for the capacitance arrays 44, 46 and 48. Note that the capacitor values are binary numbers. Thus, there would be 2⁴ total tuning center frequencies.

TABLE 1

| Capacitor | Fixed | Switched Capacitance(pF) | | | | Total Switched |
|---|---|---|---|---|---|---|
| Array | Capacitance(pF) | STAGE 51 | STAGE 53 | STAGE 55 | STAGE 57 | Capacitance (pF) |
| 44 | 8 | 2 | 4 | 8 | 16 | 30 |
| 46 | 8 | 2 | 4 | 8 | 16 | 30 |
| 48 | 180 | 3 | 6 | 12 | 24 | 45 |

Referring to FIG. 2, the capacitor arrays 44, 46 and 48 are connected to the terminals VAR_CAP1, VAR_CAP2 and VAR_CAP3 on the coaxial resonator 38. The GND1-GND5 terminals are connected to ground. The transmission lines 34, 36, 40 and 42 are not shown for clarity.

An alternate embodiment of the invention is illustrated in FIG. 3. In this embodiment, the ceramic resonator 38 and the capacitor array 48 may be replaced with a single-layer relatively high value capacitor 72, for example 9,000 pF. In this embodiment, the resonator portion is shown within the dashed box 74 and includes a pair of serially connected transmission lines 76 and 78 which have a different characteristic impedance Zo relative to the corresponding transmission lines 40 and 42, shown in FIG. 1. For example, the transmission lines 76 and 78 may be 37 mm with a characteristic impedance Zo=50 ohms. The capacitor 72 is connected to the node formed between the serially coupled transmission lines 76 and 78. A pair of switching capacitor arrays 80 and 82, similar to the arrays 44 and 46, illustrated in FIG. 1, is connected between ground and the transmission lines 76 and 78, respectively. These capacitor arrays 80 and 82 are for tuning the band-pass center frequency. The resonator 74 is connected on each end to a transmission line 84, 86, for example 20.5 mm, with a characteristic impedance zo=6.2 ohms. The transmission lines 84 and 86 are coupled to the ports 88 and 90, respectively, by way of a coupling capacitor 92, 94 for example 8 pF. Unfortunately, the Q and self-resonate frequency of the capacitor 72 is low thus will not provide high rejection on the adjacent channel (such as an adjacent TV station).

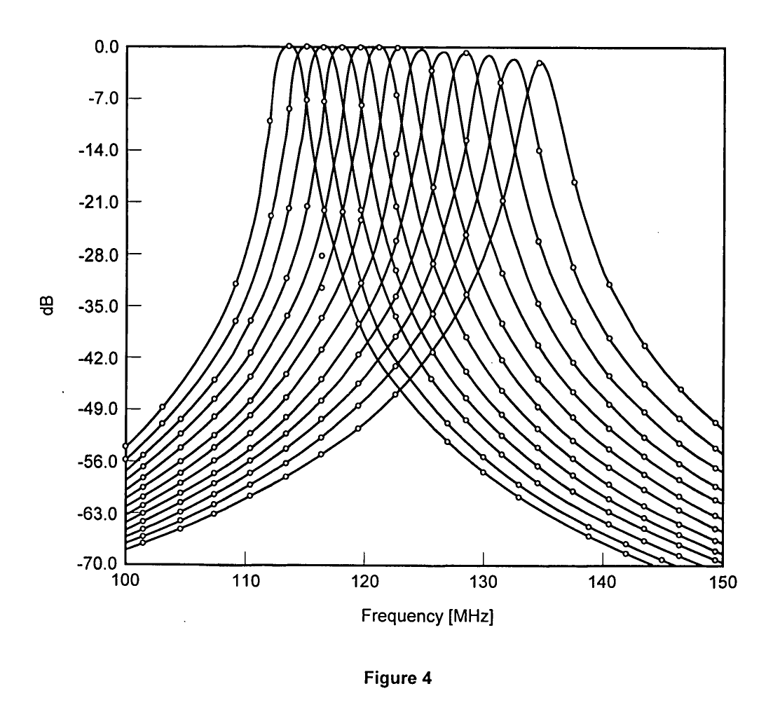

FIG. 4 illustrates the frequency response of an exemplary passband filter as illustrated in FIG. 3 utilizing different capacitor values for the coaxial resonator 38, for example 0 to 70 pF. As shown, varying the value from the ceramic resonator 38 varies the center frequency as well as the passband of the filter 20.

FIG. 5 illustrates the frequency response for a passband filter 20 using the exemplary values illustrated in FIG. 2. As shown, the filter 20 will have a center frequency of about 118 MHz and a bandwidth of about 5 MHz.

Obviously, many modifications and variations of the present invention are possible in light of the above teachings. Thus, it is to be understood that, within the scope of the appended claims, the invention may be practiced otherwise than as specifically described above.

1. A band pass filter comprising:
a ceramic coaxial resonator;
a pair of transmission lines coupled to said ceramic coaxial resonator, said pair of transmission lines and said ceramic coaxial resonator forming a resonator circuit; and
a tuning circuit for tuning said resonator circuit, said tuning circuit and said resonator circuit forming a tunable band pass filter.

2. A band pass filter as recited in claim 1, wherein said tuning circuit includes one or more switched capacitor arrays.

3. A band pass filter as recited in claim 2, wherein said switched capacitor array includes a plurality of stages, each stage including one or more capacitors.

4. A band pass filter as recited in claims 3, wherein said switched capacitor array includes a fixed capacitor in addition to the switched capacitors.

5. A band pass filter as recited in claim 4, wherein said switched capacitor array is digitally controlled.

6. A band pass filter as recited in claim 5, wherein said resonator includes two transmission lines are serially connected to one side of said ceramic resonator in a “T” configuration and a center capacitor array connected to the other end of said coaxial resonator.

7. A band pass filter as recited in claim 6, wherein said T connected transmission lines define free ends which are, in turn connected to a left capacitor array and a right capacitor array, respectively.

8. A band pass filter as recited in claim 7, wherein said center, right and left capacitor arrays are connected to grounding switches.

9. A band pass filter as recited in claim 8, wherein said grounding switches are digitally controlled.

10. A band pass filter comprising:
a capacitor;
a pair of transmission lines coupled to said capacitor, said pair of transmission lines and said capacitor forming a resonator circuit; and
a tuning circuit for tuning said resonator circuit, said tuning circuit and said resonator circuit forming a tunable band pass filter.

11. A band pass filter as recited in claim 10, wherein said tuning circuit includes a switched capacitor array.

12. A band pass filter as recited in claim 11, wherein said resonator includes two transmission lines connected to one side of said capacitor in a “T” configuration.

13. A band pass filter as recited in claim 12, wherein said T connected transmission lines define free ends which are, in turn connected to a left capacitor array and a right capacitor array respectively.

14. A band pass filter as recited in claim 13, wherein said capacitor, right and left capacitor arrays are connected to grounding switches.

15. A band pass filter as recited in claim 14, wherein said switched capacitor array includes a plurality of stages, each stage including one or more capacitors.

16. A band pass filter as recited in claim 15, wherein said switched capacitor array includes a fixed capacitor in addition to the switched capacitors.

17. A band pass filter as recited in claim 16, wherein said switched capacitor array includes a fixed capacitor in addition to the switched capacitors, wherein said switched capacitor array is digitally controlled.
